(19) United States
(12) Patent Application Publication
(10) Pub. No.: US 2026/0196391 A1
(43) Pub. Date: Jul. 9, 2026

(54) RARE EARTH ALLOY POWDER AND SINTERED MAGNET WITH REDUCTION-DIFFUSION METHOD USING OIL-SOLUBLE ALIPHATIC ORGANIC ACID/ORGANIC ACID-AMMONIUM MIXTURE

(71) Applicant: GREEN STRATEGIC MATERIALS CO., LTD., Bucheon-si, Gyeonggi-do (KR)

(72) Inventors: Soon Jae KWON, Bucheon-si, Gyeonggi-do (KR); Hwang Gyu YUN, Bucheon-si, Gyeonggi-do (KR)

(73) Assignee: GREEN STRATEGIC MATERIALS CO., LTD., Bucheon-si, Gyeonggi-do (KR)

(21) Appl. No.: 19/132,891

(22) PCT Filed: Nov. 22, 2023
(86) PCT No.: PCT/KR2023/018876

§ 371 Date: May 27, 2025

(30) Foreign Application Priority Data
Nov. 30, 2022 (KR) 10-2022-0165072

(51) Int. Cl. H01F 1/055; C22C 1/04

(52) U.S. Cl. CPC H01F 1/0557; C22C 1/0441; H01F 1/0556

(57) ABSTRACT

A method for cleaning rare earth alloy powder, includes the steps of: mixing rare earth oxides, metals, and metal compounds as raw materials, and reducing the rare earth oxides chemically to produce alloy powder that contains the reduced rare earth elements in alloy form; and cleaning the alloy powder, where the cleaning step include the steps of adding the alloy powder in a solution containing an aliphatic organic acid and an organic acid ammonium salt and removing components other than those constituting the alloy powder from the added alloy powder by the organic acid ammonium salt.

### TECHNICAL FIELD

The present disclosure provides a method of capable of manufacturing a high-quality sintered magnet by removing byproducts (e.g., CaO) under conditions where oxidation is suppressed and at the same time modifying the surface of alloy powder particles, in order to manufacture an alloy powder vulnerable to oxidation when manufacturing a rare earth alloy powder such as NdFeB using a reduction-diffusion method.

The present disclosure relates to a cleaning treatment of a rare earth alloy powder in which processes of removing byproducts/disintegrating an alloy powder agglomerated state/controlling surface (coating) are simultaneously performed using a combination of an oil-soluble aliphatic organic acid and an ammonium salt of the organic acid, and to a sintered magnet manufactured using the alloy powder thus cleaned.

### BACKGROUND ART

Rare earth magnets are utilized as key material components applied in fields such as electric vehicles, robots, urban air traffic, and wind power generation. Examples of such rare earth magnets include NdFeB magnets, and the conventional process for manufacturing them includes, first, melting a plurality of raw material metals including rare earth elements through a eutectic process, solidifying the molten metal and manufacturing an alloy powder through, for example, a multi-stage grinding process, then manufacturing a compact through, for example, a magnetic press process, and manufacturing a sintered body by high-temperature sintering of the compact, and then manufacturing a rare earth magnet through a subsequent post-processing process.

Second, there is a manufacturing process using a chemical synthesis (reduction-diffusion) method, which uses inexpensive rare earth oxides as raw materials instead of rare earth metals, and may simply manufacture rare earth alloy powder through a chemical reaction of the reduced metal, and is expected to overcome the limitations of particle refinement in the existing metallurgy process.

However, the chemical synthesis method has had limitations in industrial use because it is difficult to control powder degradation due to oxidation of rare earth alloy powder that is sensitive to oxidation reaction in the process of removing CaO, which is a byproduct of the chemical reaction.

### DISCLOSURE OF INVENTION

### Technical Problem

The present disclosure has been devised to solve the above-described problems of the related art, and an object of the present disclosure is to provide a method for effectively removing aliphatic organic acids, which may cause residual carbon during sintering, from the alloy powder while removing byproducts (e.g., CaO) in the process of removing byproducts while preventing oxidation when manufacturing rare earth magnetic alloy powder by a reduction-diffusion method.

In addition, another object of the present disclosure is to provide a method for facilitating the manufacture of rare earth magnet powder and simplifying and improving the efficiency of the sintered magnet manufacturing process by simultaneously applying a mechanical mixing process such as a ball mill while cleaning rare earth magnet powder manufactured by a reduction-diffusion process in an organic solvent containing an organic acid ammonium salt, thereby removing byproducts and disintegrating powder coagulation under oxidation-suppressed conditions, and simultaneously removing organic acid molecules from the surface of powder particles to block the generation of residual carbon during the sintering process for manufacturing sintered magnets.

### Solution to Problem

In order to achieve the above described objects, an embodiment may provide a method of cleaning a rare earth alloy powder including mixing oxide of a rare earth element, a metal and a metal compound as raw materials and reducing the rare earth oxide by chemical reduction, thereby manufacturing an alloy powder including the reduced rare earth element in a form of an alloy, and cleaning the alloy powder, wherein the cleaning includes introducing the alloy powder into a solution including an aliphatic organic acid and an organic acid ammonium salt, and removing byproducts other than components constituting the alloy powder from the introduced alloy powder by the organic acid ammonium salt.

It is preferable that the metal is Ca, the metal compound is CaH₂, and the byproduct is CaO.

It is preferable that the organic acid ammonium salt is formed by a reaction of an aliphatic organic acid and an ammonium ion having an amine as a starting material.

It is preferable that the amine is at least one of primary to tertiary amines.

It is preferable that the organic acid ammonium salt is manufactured by dissolving an aliphatic organic acid in an organic solvent, introducing a solution including ammonium ions having an amine as a starting material into the organic solvent in which the organic acid is dissolved, and reacting the aliphatic organic acid of the organic solvent with the ammonium ions to generate the organic acid ammonium salt.

It is preferable that a relative ratio of the aliphatic organic acid and the organic acid ammonium salt is adjusted by controlling an amount of an ammonium ion solution introduced into the organic solvent in which the aliphatic organic acid is dissolved.

It is preferable that the aliphatic organic acid and the solution including the ammonium ions are quantified such that a relative ratio of the organic acid ammonium salt generated compared to the aliphatic organic acid is 1% or more and 50% or less on a molar basis.

It is preferable that the rare earth alloy powder includes an NdFeB-based alloy powder.

It is preferable that an NdCuAl-based alloy powder is added to the NdFeB-based alloy powder in an amount of 3 to 7 wt % based on a weight of the NdFeB-based alloy powder.

It is preferable that, in the cleaning process, after introducing the rare earth alloy powder into an organic solvent including an organic acid ammonium salt, a mechanical mixing process is applied simultaneously.

It is preferable that the mechanical mixing process is performed by an attrition mill process by an attritor.

It is preferable that the organic solvent is kerosene or a non-polar organic solvent other than kerosene, and the organic acid is 2-ethyl hexanoic acid or an oil-soluble organic acid.

It is preferable that the solution including the aliphatic organic acid and the organic acid ammonium salt is regenerated by removing the byproducts through hydrochloric acid treatment after the byproducts are dissolved through the cleaning process.

It is preferable that the cleaned alloy powder is re-cleaned by a non-polar solvent to remove the aliphatic organic acid and the organic acid ammonium salt remaining on a surface of the alloy powder, thereby preventing generation of residual carbon when sintering the alloy powder.

In addition, the present disclosure provides a rare earth alloy powder cleaned by the method described above, wherein raw material byproducts are removed from a surface of the powder.

In addition, the present disclosure provides a method of manufacturing a rare earth sintered magnet using the rare earth alloy powder described above, the method including, loading the alloy powder into a mold; shaping by applying pressure while forming a magnetic field on the alloy powder within the mold; and sintering the shaped alloy powder.

### Advantageous Effects of Invention

According to the present disclosure as described above, an effect of effectively removing aliphatic organic acids, which may cause residual carbon during sintering, from the alloy powder while removing byproducts (e.g., CaO) in the process of removing byproducts while preventing oxidation when manufacturing rare earth magnetic alloy powder by a reduction-diffusion method may be expected.

In addition, the present disclosure may implement a method for facilitating the manufacture of rare earth magnet powder and simplifying and improving the efficiency of the sintered magnet manufacturing process by simultaneously applying a mechanical mixing process such as a ball mill while cleaning rare earth magnet powder manufactured by a reduction-diffusion process in an organic solvent containing an organic acid ammonium salt, thereby performing the removal of byproducts and the powder agglomeration disintegration under oxidation-suppressed conditions, and simultaneously removing organic acid molecules from the surface of powder particles to block the generation of residual carbon during the sintering process for manufacturing sintered magnets.

### BRIEF DESCRIPTION OF THE DRAWINGS

FIG. 1 illustrates a schematic diagram of a process for removing byproducts (CaO) mixed with rare earth powder using an organic acid and organic acid ammonium salt mixture and an attrition mill according to an embodiment of the present disclosure.

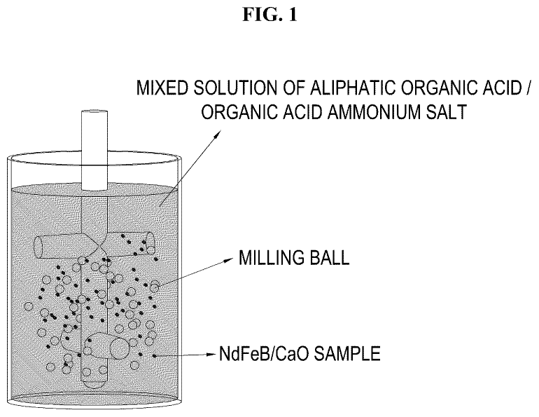

FIG. 2 illustrates a schematic diagram of manufacturing a mixture of an aliphatic organic acid and an ammonium salt of the organic acid according to an embodiment of the present disclosure.

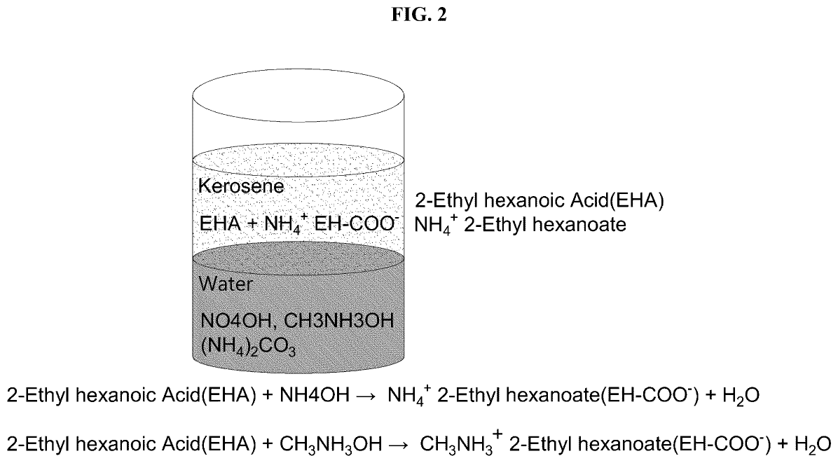

FIG. 3 illustrates a schematic diagram of removing an aliphatic organic acid from a surface of a rare earth alloy powder under conditions in which an ammonium salt of an aliphatic organic acid is present according to an embodiment of the present disclosure.

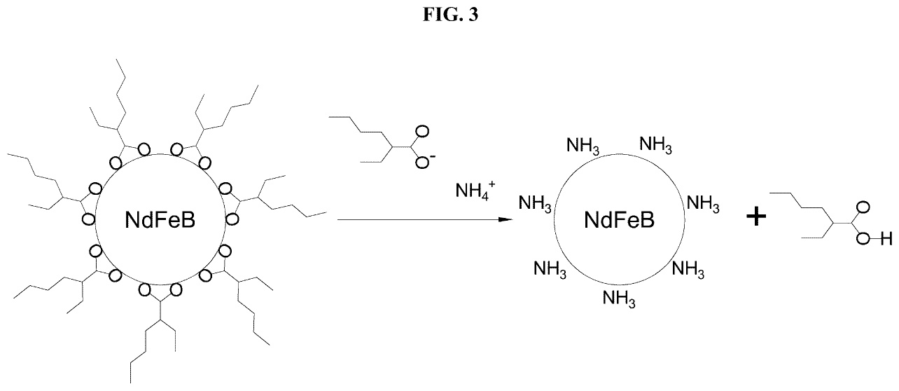

FIG. 4 illustrates a scanning electron microscope (SEM) image of a rare earth alloy powder (NdFeB) manufactured according to an embodiment of the present disclosure.

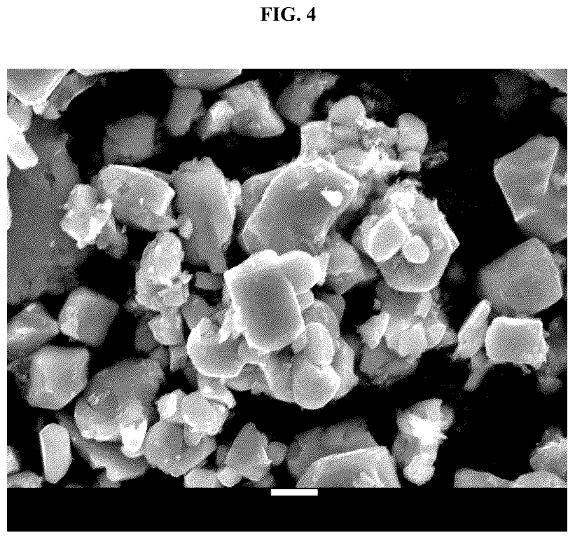

FIG. 5 illustrates a cross-sectional scanning electron microscope (SEM) image of a sintered magnet manufactured using rare earth alloy powder (NdFeB) manufactured according to an embodiment of the present disclosure.

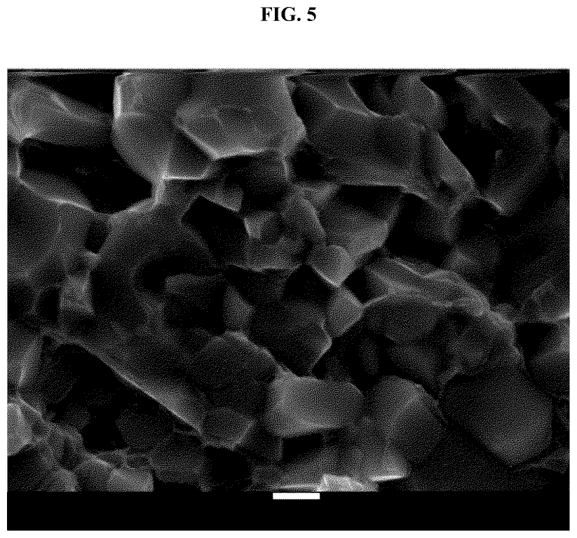

FIG. 6 illustrates performance analysis data (B—H Tracer data) of a rare earth sintered magnet manufactured according to an embodiment of the present disclosure.

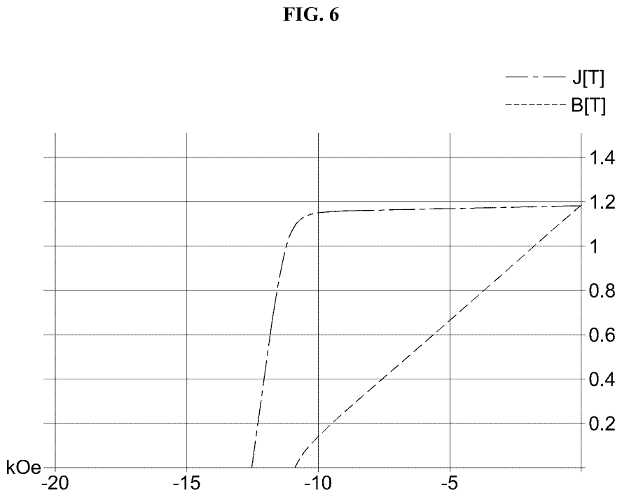

### BEST MODE

Hereinafter, various embodiments of the present disclosure will be described in detail so that a person skilled in the art may easily practice the present disclosure. The present disclosure may be implemented in various different forms and is not limited to the embodiments described herein.

The NdFeB magnetic powder used in the present disclosure is a powder manufactured by applying a reduction-diffusion method, and the composition of the magnetic powder and the manufacturing method of the powder are not limited thereto.

A method of manufacturing a magnetic powder according to an embodiment of the present disclosure includes a synthesis step of synthesizing, for example, an R-Fe-B-based magnetic powder by a reduction-diffusion method; a step of cleaning the R—Fe—B-based magnetic powder; a step of filling a mold with the cleaned R—Fe—B-based magnetic powder; a step of applying a pulsed magnetic field to orient the powder; and a step of sintering under vacuum conditions.

Here, R refers to a rare earth element and may be Nd, Pr, Dy, or Tb. In other words, R described below means Nd, Pr, Dy, or Tb.

The present disclosure provides a method for effectively manufacturing a magnet powder that is easy to sinter while efficiently removing a reaction byproduct (CaO) in a powder manufacturing process of a reduction-diffusion method as a method for replacing the existing method of melting-grinding metal alloys in the manufacturing of rare earth magnet alloy powder. In other words, the present disclosure aims at removing reaction byproducts and effectively manufacturing magnetic powder.

The present disclosure may be applied to cleaning all kinds of rare earth alloy powders, and the composition of the byproducts removed may also be diverse.

Therefore, it is obvious that the composition of the rare earth alloy powder and the composition of the byproducts are not limited to a specific composition.

In the present disclosure, in order to provide a method for simultaneously implementing oxidation inhibition, disintegration (separation) of agglomerated powder particles, and surface control of alloy powder particles in removing byproducts in the step of manufacturing a rare earth alloy powder (e.g., NdFeB powder) using a reduction-diffusion process, an organic solvent (oil) is used instead of a water/alcohol-based solvent.

Here, a fat-soluble organic acid capable of forming a complex by reacting with the byproduct, for example, calcium oxide (CaO), is applied so that the byproduct is dissolved and diffused into the organic solvent.

In addition, in the present disclosure, the aliphatic organic acid may be bound (adsorbed) to the surface of the rare earth alloy powder particles and form residual carbon during sintering, which may hinder the manufacture of a sintered magnet, and thus, an amine (ammonium) derivative was introduced so that the aliphatic organic acid does not bind well. In general, small-molecule amines or ammonium salts do not dissolve in non-polar organic solvents, and to solve this, an ammonium salt derivative of an aliphatic organic acid was formed so that the ammonium salt is dissolved in the non-polar organic solvent.

In addition, a ball mill process was applied simultaneously to implement the removal of byproducts and the agglomeration disintegration of particles at the same time. Among the ball mill methods, an attrition mill was applied to enable gas discharge instead of a sealed ball mill container so that gases that may be generated during the byproduct removal process may be released.

A non-polar organic solvent such as hexane is used to prevent oxidation of rare earth alloy powder while removing aliphatic organic acids and the corresponding ammonium salts which may remain, and to facilitate solvent removal.

Amine (R—NH₂) molecules including ammonia (NH₃) have the characteristic of forming bonds with metal ions or metal surfaces that have d-orbitals or f-orbitals in their atomic structures, but do not react with atoms or surfaces, such as calcium (Ca), that do not have such atomic orbitals.

When bonded with a metal element having a d-orbital or f-orbital, amine (R—NH₂) molecules including ammonia (NH₃) bind more strongly than the carboxy functional group, which is an organic acid functional group applied in the reduction-diffusion method, so it is possible to replace the bonding of the organic acid, and this characteristic also functions in the form of an ammonium (R—NH₃⁺) cation.

When manufacturing a rare earth magnet (NdFeB) powder by the reduction-diffusion method using an aliphatic organic acid dissolved in an organic solvent, a method of removing byproducts (CaO) while suppressing powder oxidation may be provided, but the manufacture of a rare earth sintered magnet is possible only when the aliphatic organic acid molecules bonded to the surface of the rare earth alloy powder are removed. The reason is that if oil-soluble aliphatic organic acids are not properly removed, the remaining organic acids generate a large amount of residual carbon during the manufacture of sintered magnets, so an additional process for removing the organic acids on the surface is necessary for the manufacture of sintered magnets.

As a method of removing aliphatic organic acids adsorbed (bonded) to the surface of alloy powders while removing byproducts including CaO under conditions that suppress oxidation of the alloy powder, the present disclosure proposes a method of mixing an aliphatic organic acid and an ammonium salt of the corresponding organic acid with an organic solvent.

By introducing the ammonium salt of the aliphatic organic acid into the organic solvent, a water-free organic acid ammonium salt solution is manufactured and used, and the relative ratio of the aliphatic organic acid and the organic acid ammonium salt may be easily controlled by adjusting the amount of the ammonium salt in the aqueous solution.

To this end, the quantitative reaction of acid (organic acid)-base (ammonium solution) at an organic solvent-ammonium solution interface induces the production of ammonium salts, which are reaction products of organic acid functional groups and ammonium ions in the organic solvent (oil) layer.

Typically, in order to form R₂Fe₁₄B magnet powder such as Nd₂Fe₁₄B, the raw material is melted at a high temperature of 1500 to 2000 degrees C., and then rapidly cooled to manufacture a bulk of the raw material, and the bulk material is subjected to coarse grinding/hydrogen crushing/jet-milling, etc., to obtain the R₂Fe₁₄B magnet powder. In addition, a magnetic field shaping method is applied as a method of orienting the particles, and a high pressure of tens to hundreds of Mpa must be applied to the alloy powder under a direct current magnetic field in the absence of oxygen (inert conditions). In order to apply such a high pressure, a large press needs to be used, but it is difficult to accommodate a large press in a sealed container.

In addition, in order to apply the finally sintered rare earth magnet to applications such as motors, an additional process of cutting/trimming to the required dimensions and shapes is required. This requires expensive equipment, difficult processes, etc., and thus has a high possibility of improvement.

In the present disclosure, rather than using a method of manufacturing rare earth powder through metal melting/grinding and shaping a sintered magnet by applying high pressure, a method of filling powder into a mold and then applying a pulse magnetic field to orient and sinter is used, and as a prerequisite for this, refinement of powder particles is important, and to this end, powder having a particle size of around 2 μm is useful for applying this method.

### EXAMPLE

In order to help understand the present disclosure, the present disclosure will be described in detail based on the preferred examples below. However, the examples below are only preferred examples for deriving the present disclosure, and changes in raw materials, usage amounts, and the like, are possible.

Nd₂₃ 37g, Fe 66 g, B 0.92 g, Cu 0.4 g, Ca 17 g were uniformly mixed and placed in a container of any size, and heated at 950° C. for 1 hour in an inert gas (Ar, He) atmosphere to react, thereby synthesizing a rare earth alloy powder. Since the conditions for synthesizing the rare earth alloy powder are known techniques, a detailed description will be omitted.

In order to prevent surface oxidation of the alloy powder caused by byproducts during the process of sintering the rare earth alloy powder thus synthesized, a mixture of an aliphatic organic acid and an ammonium salt of the organic acid is manufactured in an organic solvent (e.g., kerosene) and used to remove CaO, which is a reaction byproduct. In addition to CaO, other substances may be generated as byproducts depending on the raw materials used.

For example, 700 ml of kerosene is used as an organic solvent and 300 ml of 2-ethyl hexanoic acid (aliphatic organic acid) is mixed therewith. When an aqueous solution containing 5 g of ammonium carbonate ((NH₄)2CO₃) is added to this mixed solution, a boundary is formed between the lower aqueous solution layer and the upper organic solvent layer in which the organic acid is dissolved. When stirring is performed with a mechanical stirrer, an ammonium salt of an aliphatic organic acid (aliphatic organic acid-based ammonium salt) is formed by an acid-base reaction between the organic acid and ammonium carbonate at the interface between the aqueous solution layer and the organic solvent in which the organic acid is dissolved, and the ammonium salt is dissolved in the organic solvent in which the organic acid is dissolved. As a result, a mixed solution of an aliphatic organic acid and an organic acid ammonium salt quantitatively reacted with ammonium carbonate is generated.

The relative ratio of the organic acid ammonium salt to the aliphatic organic acid may be 1% to 50% on a molar basis, and when the organic acid ammonium salt reacts with the NdFeB surface, the ammonium salt (NH₄⁺ or R-NH₃⁺) is converted to ammonia (NH₃) or amine (R-NH₂) and is adsorbed or bound, so there is no need for an excessive amount. If the amount of the organic acid ammonium salt is less than the above range, the cleaning effect is low, and if it exceeds the above range, the viscosity of the solution may increase, which may lower the effect of the reaction and calcium oxide (CaO) cleaning/removal. In other words, if the amount of organic acid ammonium salt exceeds the critical value compared to the aliphatic organic acid, the liquidity of the overall solution becomes alkaline, which may lower the effect of removing calcium oxide (CaO), and the above ratio has critical significance within that range.

The byproduct calcium oxide (CaO) reacts with the above mixed solution and dissolves in the form of Ca(EHA)₂, i.e., calcium 2-ethyl hexanoate, and becomes mixed with the aliphatic organic acid and organic acid ammonium salt, and when the solution treated with the byproduct in this way is regenerated using an aqueous hydrochloric acid solution, the removed byproduct calcium oxide (CaO) is removed by dissolving in the aqueous layer in the form of calcium chloride (CaCl₂), and the organic acid ammonium salt is removed by dissolving in the aqueous layer in the form of ammonium chloride (NH₄Cl), so that the organic solvent-organic acid solution is regenerated and may be repeatedly reused. In addition to hydrochloric acid, inorganic acids such as sulfuric acid (H₂SO₄), nitric acid (HNO₃), phosphoric acid (H₃PO₄), and organic acids such as formic acid, lactic acid, and oxalic acid with higher acidity than organic acids may also be applied.

Afterwards, in order to prevent organic acids and organic acid ammonium salts from remaining in the NdFeB powder and forming residual carbon during the manufacture of sintered magnets, the powder is washed twice with hexane to remove organic substances, and vacuum-dried. At this time, hexane is a nonpolar solvent, and a type of nonpolar solvent other than hexane may also be used.

To the manufactured NdFeB powder, 5 wt % of Nd₅₀Cu_{2.8}Al_{4.1} (based on weight ratio) alloy powder is added based on the weight ratio of the manufactured NdFeB powder, and mixed uniformly using a Paste Mixer. The Nd₅₀Cu_{2.8}Al_{4.1} powder was manufactured by applying a reduction-diffusion method in which Nd₂O₃, Cu, Al, and Ca were mixed and then heated.

The Nd—Cu—Al alloy forms a eutectic alloy that has a lower melting point than each metal, such as Nd and Cu, and melts at about 500 to 600° C., which is much lower than the melting point of Nd metal (1024° C.), so that it may induce partial melting between NdFeB particles, thereby playing a role in increasing sintering efficiency. In addition, it is difficult to manufacture alloy powders such as Nd—Cu—Al using the existing metal melting method, but it is possible to efficiently manufacture Nd—Cu—Al and powders of various alloy compositions through a chemical reaction of the reduction-diffusion method, and apply them to the manufacture of sintered magnets. More generally, the NdCuAl-based alloy powder may be added to the NdFeB-based alloy powder in an amount of 3 to 7 wt % based on the weight of the NdFeB-based alloy powder and used as a sintering aid. Here, when it is less than 3 wt %, there is no effect of increasing the sintering efficiency, and when it exceeds 7 wt %, the sintering efficiency is increased, but when the NdFeB synthetic powder is manufactured into a sintered magnet later, there may be side effects such as performance deterioration and mechanical strength reduction due to excessive crystal growth, and therefore the NdCuAl-based powder has critical significance in the above range.

Finally, the powder was filled into a cylindrical mold, a pulse magnetic field with an instantaneous magnetic field strength of 5 Tesla was applied to orient the powder, and it was heated in a vacuum sintering furnace to manufacture a sintered magnet. The process of manufacturing a sintered magnet in this way is a known technology and may be modified in various ways, so a detailed description will be omitted.

1. A method of cleaning a rare earth alloy powder, the method comprising:
mixing oxide of a rare earth element, a metal and a metal compound as raw materials and reducing the rare earth oxide by chemical reduction, thereby manufacturing an alloy powder including the reduced rare earth element in a form of an alloy; and
cleaning the alloy powder,
wherein the cleaning comprises:
introducing the alloy powder into a solution including an aliphatic organic acid and an organic acid ammonium salt; and
removing byproducts other than components constituting the alloy powder from the introduced alloy powder by the organic acid ammonium salt.

2. The method according to claim 1, wherein the metal is Ca, the metal compound is CaH₂, and the byproduct is CaO.

3. The method according to claim 1, wherein the organic acid ammonium salt is formed by a reaction of an aliphatic organic acid and an ammonium ion having an amine as a starting material.

4. The method according to claim 3, wherein the amine is at least one of primary to tertiary amines.

5. The method according to claim 1, wherein the organic acid ammonium salt is manufactured by:
dissolving an aliphatic organic acid in an organic solvent;
introducing a solution including ammonium ions having an amine as a starting material into the organic solvent in which the organic acid is dissolved; and
reacting the aliphatic organic acid of the organic solvent with the ammonium ions to generate the organic acid ammonium salt.

6. The method according to claim 5, wherein a relative ratio of the aliphatic organic acid and the organic acid ammonium salt is adjusted by controlling an amount of an ammonium ion solution introduced into the organic solvent in which the aliphatic organic acid is dissolved.

7. The method according to claim 5, wherein the aliphatic organic acid and the solution including the ammonium ions are quantified such that a relative ratio of the organic acid ammonium salt generated compared to the aliphatic organic acid is 1% or more and 50% or less on a molar basis.

8. The method according to claim 1, wherein the rare earth alloy powder comprises an NdFeB-based alloy powder.

9. The method according to claim 8, wherein an NdCuAl-based alloy powder is added to the NdFeB-based alloy powder in an amount of 3 to 7 wt % based on a weight of the NdFeB-based alloy powder.

10. The method according to claim 1, wherein, in the cleaning process, after introducing the rare earth alloy powder into an organic solvent including an organic acid ammonium salt, a mechanical mixing process is applied simultaneously.

11. The method according to claim 10, wherein the mechanical mixing process is performed by an attrition mill process by an attritor.

12. The method according to claim 5, wherein the organic solvent is kerosene or a non-polar organic solvent other than kerosene, and the organic acid is 2-ethyl hexanoic acid or an oil-soluble organic acid.

13. The method according to claim 1, wherein the solution including the aliphatic organic acid and the organic acid ammonium salt is regenerated by removing the byproducts through hydrochloric acid treatment after the byproducts are dissolved through the cleaning process.

14. The method according to claim 1, wherein the cleaned alloy powder is re-cleaned by a non-polar solvent to remove the aliphatic organic acid and the organic acid ammonium salt remaining on a surface of the alloy powder, thereby preventing generation of residual carbon when sintering the alloy powder.

15. A rare earth alloy powder cleaned by the method according to claim 1, wherein raw material byproducts are removed from a surface of the powder.

16. A method of manufacturing a rare earth sintered magnet using the rare earth alloy powder according to claim 15, the method comprising:
loading the alloy powder into a mold;
shaping by applying pressure while forming a magnetic field on the alloy powder within the mold; and
sintering the shaped alloy powder.

17. The method according to claim 10, wherein the organic solvent is kerosene or a non-polar organic solvent other than kerosene, and the organic acid is 2-ethyl hexanoic acid or an oil-soluble organic acid.
